(19) United States
(12) Patent Application Publication
(10) Pub. No.: US 2017/0246913 A1
(43) Pub. Date: Aug. 31, 2017

(54) Pneumatic Vehicle Tires Comprising a Belt Bandage

(71) Applicant: CONTINENTAL REIFEN DEUTSCHLAND GMBH, Hannover (DE)

(72) Inventor: WOLFGANG Reese, Peine (DE)

(73) Assignee: Continental Reifen Deutschland GmbH, Hannover (DE)

(21) Appl. No.: 15/513,191

(22) PCT Filed: Aug. 4, 2015
(86) PCT No.: PCT/EP2015/067899

§ 371 Date: Mar. 22, 2017

(30) Foreign Application Priority Data
Oct. 9, 2014 (DE) 10 2014 220 518.2

(51) Int. Cl. B60C 9/22; B60C 9/00

(52) U.S. Cl. CPC B60C 9/22; B60C 9/0042; B60C 9/005; B60C 2009/0078; B60C 2009/2223; B60C 2009/2257; B60C 2009/2261

(57) ABSTRACT

Pneumatic vehicle tyres which have a bandage ply (8) comprising two lateral portions (10) and a center portion (12) in the axial extension, wherein each lateral portion (10) has at least one hybrid reinforcement, and wherein the center portion (12) has at least one reinforcement which has a lower modulus of elasticity than the hybrid reinforcements of the lateral portions (10), in each case measured as per ASTM D885M at an elongation of 3%. It is the object of the invention to provide a tyre with reduced rolling resistance and good high-speed characteristics with reliable producibility. This is achieved in that the hybrid reinforcement is a hybrid cord made of at least one low-modulus thread and one high-modulus thread twisted together, and in that the hybrid reinforcement has a fineness of at most 550 dtex, preferably at most 500 dtex, particularly preferably at most 460 dtex, and in that the reinforcement of the center portion (12) has a fineness of at most 1100 dtex, preferably at most 600 dtex, particularly preferably at most 500 dtex.

The invention relates to a pneumatic vehicle tire having a carcass, a profiled tread, a belt and a single- or multi-ply belt bandage having strength members running in the circumferential direction of the tire which covers this belt, wherein at least one bandage ply of the belt bandage comprises in its axial extent two lateral sections, each comprising an axial edge of the bandage ply, and a central section arranged between the two lateral sections, wherein each lateral section comprises at least one hybrid strength member and wherein the central section comprises at least one strength member having a lower modulus of elasticity than the hybrid strength members of the lateral sections, in each case measured as per ASTM D885M at an extension of 3%.

In the case of pneumatic vehicle tires, to prevent expansion of the tire due to the centrifugal forces occurring during driving, in particular during high-speed use, it is known to provide in a pneumatic vehicle tire, which generally comprises an air-impermeable inner layer, a strength-member-comprising radial carcass which reaches from the region of the crown of the tire over the sidewalls into the bead region and is anchored there by wrapping around high-tensile bead cores, a rubber tread that is located radially on the outside and has tread grooves, and a belt arranged between the rubber tread and the carcass, a belt bandage. The belt bandage may be a single- or multi-ply bandage, covers at least the belt edges and comprises strength members running parallel and substantially in the circumferential direction which are embedded in rubber.

During tire production, the bandage is applied in the form of plies comprising strength members embedded in an unvulcanized rubber mixture which are wound or coiled onto the belt. The strength members for such plies are embedded in rubber by a set of essentially parallel strand-shaped strength members, which have generally been pretreated thermally and/or with impregnation for better adherence to the embedding gum in a manner known to one skilled in the art, passing in the longitudinal direction through a calender or an extruder for sheathing with a rubber mixture.

The strength members of the belt bandage are intended to allow sufficient expansion at the shaping stage and also in the vulcanization mold during tire production in order that the tire may be precision formed, and they are intended to ensure, once the tire is finished, good high-speed serviceability when driving.

During shaping and vulcanization of the tire, the tire generally expands/extends by about 0.1% to 1.5% in the shoulder region and by about 2% to 4% in the central region compared to the unvulcanized green tire when the green tire is wound on a flat drum. To meet these requirements, the strength members should have a breaking extension sufficient for tire manufacture and in the central region of the pneumatic vehicle tire be extendable up to an extension of about 3% to 4% under a moderate force and to a higher extension only under a very high force.

EP 1580030 B1 discloses a pneumatic vehicle tire according to the preamble whose belt bandages in their central section comprise cords made of PA 6.6 having a lower modulus of elasticity than the cords of the lateral sections which are in the form of a composite of aramid fibers and PA 6.6 fibers. During driving, in particular in high-speed use, the use of higher-modulus material in the lateral regions allows for good absorption of the forces arising there while as a result of the lower-modulus PA6.6 in the central region the pneumatic vehicle tire develops a round contour and thus exhibits positive high-speed properties. Such a belt bandage thus has a positive effect on the high-speed strength and long-term durability of the pneumatic vehicle tire.

There is a trend toward improving rolling resistance. It is known that use of thin high-modulus materials as strength members in the belt bandage contributes to an improvement in rolling resistance. However, conflictingly, high-modulus materials having an insufficient breaking expansion do not allow for construction on an expansion drum.

The invention has for its object to provide a pneumatic vehicle tire which comprises a belt bandage and has reduced rolling resistance and good high-speed properties and which is additionally capable of reliable production.

This object is achieved in accordance with the invention when the at least one hybrid strength member of each lateral section is a hybrid cord made of at least two yarns twisted together, wherein at least a first yarn is a high-modulus yarn and wherein a further yarn is a low-modulus yarn, when the at least one hybrid strength member of each of the lateral sections have a fineness of not more than 550 dtex, preferably of not more than 500 dtex, particularly preferably of not more than 460 dtex and when the at least one strength member of the central section has a fineness of not more than 1100 dtex, preferably of not more than 600 dtex, particularly preferably of not more than 500 dtex.

In the context of the invention it has been found that such strength members having such a low fineness are very suitable for the belt bandage of pneumatic vehicle tires.

The strength members in the lateral sections are hybrid cords made of at least one high-modulus yarn and at least one low-modulus yarn twisted together. This puts the high-modulus yarn on a helical path in order to provide it with scope for constructive extension in the hybrid cord and to increase breaking extension. However, a reduction in the fineness of such hybrid cords to improve rolling resistance generally results in a lower constructive extension potential and thus in a decline in breaking extension.

In the context of the present invention, as per DIN 60900, a “yarn” is a linear construct consisting of individual filaments or fibers. The filaments or fibers of the yarn are preferably twisted together. A “cord” consists of two or more yarns twisted together. The fineness of a cord is calculated as the sum of the finenesses of the yarns of the cord.

The term “high-modulus yarn” is to be understood as meaning a yarn that consists of a high-modulus material. The term “low-modulus yarn” is to be understood as meaning a yarn that consists of a low-modulus material. The low-modulus yarn and the high-modulus yarn are defined on the basis of the values in (mN/tex) that are described in table 1 which follows. The force that must be applied to a yarn for 1% extension and for 2% extension respectively is determined, normalized to the yarn fineness in tex. Determination is in accordance with ASTM D885.

TABLE 1

| | Yarn/extension | |
|---|---|---|
| | 1% | 2% |
| Low-modulus | <150 mN/tex | <200 mN/tex |
| High-modulus | >300 mN/tex | >500 mN/tex |

Key to the invention is employing thin hybrid cords featuring a very low fineness of not more than 550 dtex, preferably of not more than 500 dtex, particularly preferably of not more than 460 dtex, in the two lateral regions of the belt bandage in which the requirements for breaking extension of the strength members are lower than in the central region. This means that the belt ply in the lateral sections may be made thinner, thus reducing the weight of the tire and the heat build-up as the tire rolls. This reduces the rolling resistance of the tire. It has been found that a reduction in the fineness of the higher-modulus strength members of the lateral regions has a positive effect on rolling resistance. Such thin cords may also be arranged in higher density, as a result of which the belt bandage ensures very good high-speed durability.

The lower-modulus strength member(s) of the central section ensure the sufficient expansion during tire construction and during use. These strength members too have a lower fineness which has a positive effect on rolling resistance.

The use of high-modulus material in the lateral sections and the use of strength members in the central section whose modulus of elasticity is lower than the modulus of elasticity of the hybrid cords of the lateral sections ensures continued very good high-speed properties of the tire.

The invention accordingly provides a pneumatic vehicle tire having a belt bandage which exhibits reduced rolling resistance and which allow the different expansion requirements in the axial regions of the tire during shaping and in the vulcanization mold and is thus capable of reliable production while ensuring continued good high-speed properties.

For problem-free tire construction it is sufficient when the breaking extension of the hybrid strength members of the lateral sections is in a range from 4% to 7%, preferably in a range from 5% to 6%.

To ensure expansion of the tire in the central region it is advantageous when the breaking extension of the strength member in the central region is at least 7%, preferably at least 8%.

The breaking extension is determined as per ASTM D885.

The high-modulus yarn advantageously consists of one of the following materials: aramid fibers, carbon fibers, glass fibers, basalt. The high-modulus yarn preferably consists of aramid fibers, preferably fibers made of para-aramid or meta-aramid.

The low-modulus yarn advantageously consists of a polyamide or a polyester. The polyamides (PA) may be the polyamides PA 4.6, PA 6, PA 6.6, PA 10.10, PA 11 and/or PA12, preferably PA 6.6 or PA 10.10. The polyesters may be the polyesters polyethylene naphthalate (PEN), polyethylene furanoate (PEF), polybutylene terephthalate (PBT), polybutylene naphthalate (PBN), polypropylene terephthalate (PPT), polypropylene naphthalate (PPN), polyethylene terephthalate (PET), in particular thermoplastic polyesters and/or crosslinked unsaturated polyesters.

In a preferred embodiment the individual yarns of the hybrid cords of the lateral sections each have a fineness of not more than 320 dtex, preferably of not more than 240 dtex. It has been found that the hybrid cords made of such thin yarns are exceptionally suitable for the lateral sections of a belt bandage and that such a belt bandage exhibit reduced rolling resistance.

It is advantageous when the hybrid cords of the lateral sections are formed from precisely two or from precisely three yarns. It is furthermore advantageous when the hybrid cords of the lateral sections are formed from precisely two yarns end-twisted together, wherein the first yarn is an aramid yarn having a fineness of 220 dtex and the second yarn is either a PA 6.6 yarn having a fineness of 235 dtex or a PET yarn having a fineness of 238 dtex.

It is advantageous when the strength member of the central section is a yarn or a cord.

It is advantageous when the strength member of the central section consists of a polyamide (PA), preferably of PA 6.6 or PA 10.10, or a polyester, preferably of polyethylene terephthalate (PET).

To ensure reliable adhesion of a strength member to the rubber it is advantageous when the strength members of the bandage ply are provided with an adhesive impregnation, for example with an RFL dip in a 1- or 2-bath operation, and stretched with application of heat.

It has proven advantageous when each lateral section on its axial side of the tire covers at least the belt edge of the radially outermost belt ply and the axially outermost belt edge of the belt.

It is advantageous when the belt bandage is a single-ply belt bandage. However, it is also advantageous when the belt bandage comprises two or more bandage plies, wherein at least one of the bandage plies encompasses the central section and the two lateral sections.

The belt bandage is particularly preferably a belt bandage of a passenger car.

Further features, advantages and particulars of the invention are now elucidated in more detail having reference to the schematic drawings which depict working examples.

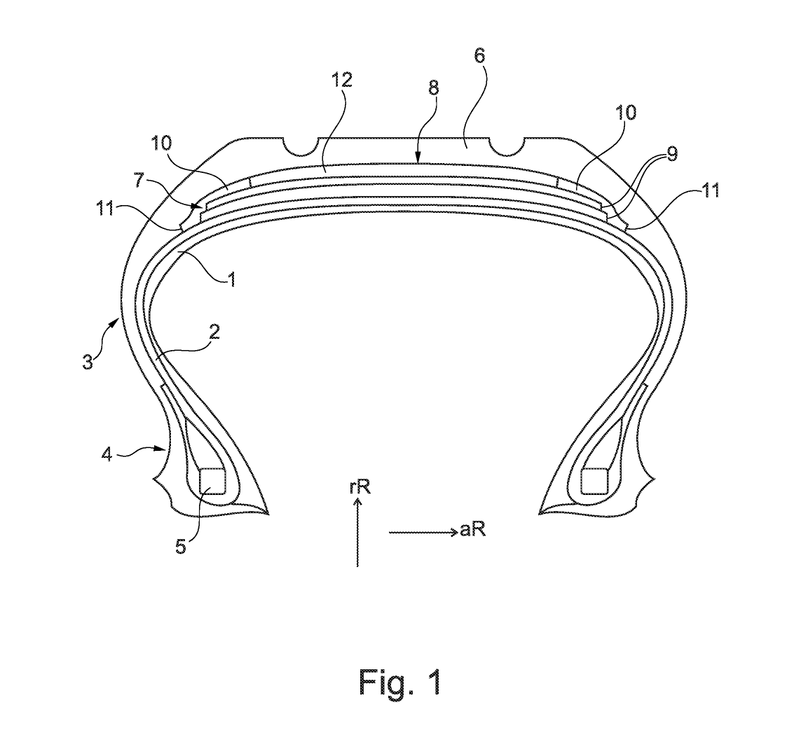

FIG. 1 shows a radial cross section through a pneumatic vehicle tire according to the invention;

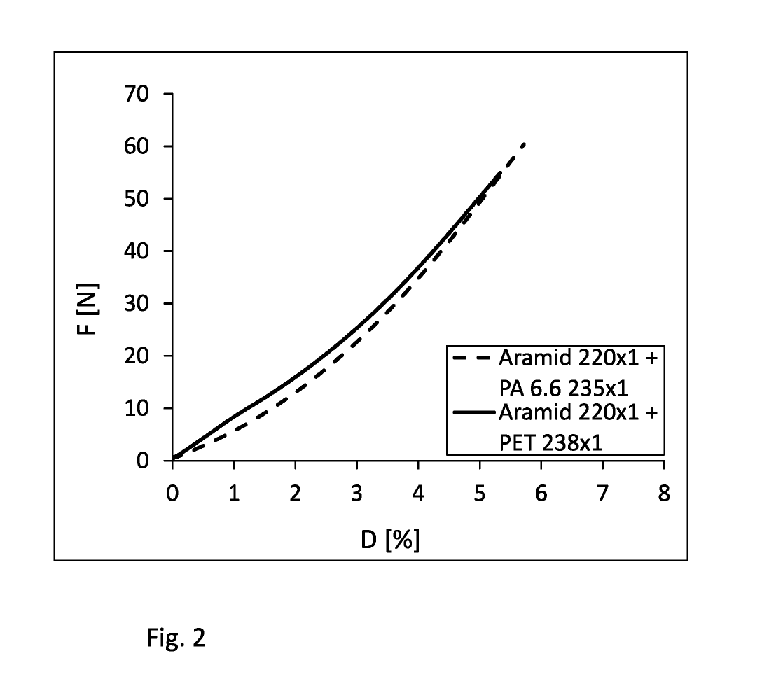

FIG. 2 shows a force-extension curve of strength member cords suitable in the context of the invention.

FIG. 1 shows a radial cross section through a pneumatic vehicle tire for a passenger car. The essential components from which the depicted pneumatic vehicle tire is composed are a largely air-impermeable inner layer 1, a carcass 2 which conventionally reaches from the region of the crown of the pneumatic vehicle tire over the sidewalls 3 into the bead regions 4 and is anchored there by wrapping around high-tensile bead cores 5, a profiled tread 6 located radially outside the carcass and a belt 7 arranged between the tread 6 and the carcass 2 and comprising two strength member plies which is radially covered on the outside with the belt bandage which comprises a bandage ply 8. The bandage ply covers the belt edges 9 and comprises strength members wound along the axial width in parallel in the circumferential direction of the pneumatic vehicle tire.

The bandage ply 8 comprises in its axial extent two lateral sections 10, each comprising an axial edge 11 of the bandage ply 8, and a central section 12 arranged between the two lateral sections 10. Each of the two lateral section 10 covers on its axial side of the tire at least the belt edge 9 of the radially outermost belt ply and the axially outermost belt edge 9 of the belt 7.

The strength members of the two lateral sections 10 are hybrid cords made of a high-modulus yarn and a low-modulus yarn and have a cord fineness of not more than 550 dtex, preferably of not more than 500 dtex, particularly preferably of not more than 460 dtex. The breaking extension of the hybrid cords is 5% to 6%. The strength member(s) of the central section 12 are cords of two low-modulus yarns twisted together and have a lower modulus of elasticity than the hybrid cords of the lateral sections 10, in each case measured as per ASTM D885M at an extension of 3%. Furthermore, the cord fineness is not more than 1100 dtex, preferably not more than 600 dtex, particularly preferably not more than 500 dtex. The breaking extension is at least 7%. The strength members of the belt bandage ply 8 have been provided with an RFL dip and stretched with application of heat.

In one embodiment of the invention the high-modulus yarn of the hybrid cords of the lateral sections 10 is an aramid yarn having a fineness of 220 dtex and the low-modulus yarn is either a PA 6.6 yarn having a fineness of 235 dtex or a PET yarn having a fineness of 238 dtex. The strength member(s) of the central section 12 are formed from two twisted-together yarns of PA 6.6 having a fineness of 470 dtex or less or of two twisted-together yarns of PET having a fineness of 550 dtex or less.

FIG. 2 shows force-extension curves, determined as per ASTM D885, of dipped hybrid cords for use in the lateral regions of the belt bandage of a pneumatic vehicle tire as shown in FIG. 1. “Dipped” is to be understood as meaning that: after twisting the cord has been impregnated in a manner known to those skilled in the art with a dip solution, thus providing it with a rubber-friendly finish, and stretched with application of heat. The horizontal axis shows extension D, the vertical axis force F.

Force-extension curves of the two above-described hybrid cords having the constructions aramid 220x1+PA 6.6 235x1 and aramid 220x1+PET 238x1 are depicted. It is apparent that both hybrid cords have a breaking extension of 5% to 6%. This ensures sufficient expansion in the lateral regions during tire construction.

It is furthermore apparent that the central cords have a lower modulus of elasticity at 3% expansion than the hybrid cords of the lateral sections. The use of high-modulus aramid material in the lateral regions ensures good absorption of the forces arising there, in particular in high-speed use, while in the central region the pneumatic vehicle tire develops a round contour as a result of the lower-modulus PA6.6 or PET and thus exhibits positive high-speed properties.

### LIST OF REFERENCE NUMERALS

(Part of the Description)

1 inner layer

2 carcass

3 sidewall

4 bead region

5 bead core

6 tread

7 belt

8 bandage ply

9 belt edge

10 lateral section

11 axial edge of bandage ply

12 central section

aR axial direction

rR radial direction

1.-10. (canceled)

11. A pneumatic vehicle tire comprising a carcass, a profiled tread, a belt and a single or multi-ply belt bandage having strength members running in the circumferential direction of the tire which covers this belt;
wherein at least one bandage ply of the belt bandage comprises in its axial extent two lateral sections, each comprising an axial edge of the bandage ply, and a central section arranged between the two lateral sections;
wherein each of the two lateral sections comprises at least one hybrid strength member;
wherein the central section comprises at least one strength member having a lower modulus of elasticity than the hybrid strength members of the two lateral sections, the modulus of elasticity measured as per ASTM D885M at an extension of 3%;
wherein the at least one hybrid strength member of each the two lateral sections is a hybrid cord made of at least two yarns twisted together, and wherein at least a first yarn is a high-modulus yarn and wherein a further yarn is a low-modulus yarn;
wherein the at least one hybrid strength member of each of the two lateral sections have a fineness of not more than 550 dtex; and,
wherein the at least one strength member of the central section has a fineness of not more than 1100 dtex.

12. The pneumatic vehicle tire as claimed in claim 11, wherein the breaking extension of the hybrid strength members of the two lateral sections is in a range from 4% to 7%.

13. The pneumatic vehicle tire as claimed in claim 12, wherein the breaking extension of the hybrid strength members of the two lateral sections is in a range from 5% to 6%.

14. The pneumatic vehicle tire as claimed in claim 11, wherein the breaking extension of the strength member in the central section is at least 7%, preferably at least 8%.

15. The pneumatic vehicle tire as claimed in claim 14, wherein the breaking extension of the strength member in the central section is at at least 8%.

16. The pneumatic vehicle tire as claimed in claim 12, wherein the high-modulus yarn comprises aramid fibers, carbon fibers, glass fibers or basalt.

17. The pneumatic vehicle tire as claimed in claim 12, wherein the low-modulus yarn the low-modulus yarn comprises a polyamide 6.6, polyamide 10.10, or a polyester.

18. The pneumatic vehicle tire as claimed in claim 17, wherein the low-modulus yarn the low-modulus yarn comprises a polyethylene terephthalate (PET).

19. The pneumatic vehicle tire as claimed in claim 12, wherein individual yarns of the hybrid cords of the two lateral sections have a fineness of not more than 320 dtex.

20. The pneumatic vehicle tire as claimed in claim 12, wherein individual yarns of the hybrid cords of the two lateral sections have a fineness of not more than 240 dtex.

21. The pneumatic vehicle tire as claimed in claim 11, wherein the strength member of the central section is a yarn or a cord.

22. The pneumatic vehicle tire as claimed in claim 11, wherein the strength member of the central section comprises a polyamide 6.6, polyamide 10.10, or a polyester.

23. The pneumatic vehicle tire as claimed in claim 22, wherein the strength member of the central section comprises a polyethylene terephthalate (PET).

24. The pneumatic vehicle tire as claimed in claim 11, wherein the two lateral sections, on an axial side of the pneumatic vehicle tire, cover at least a belt edge of the radially outermost belt ply of the belt.

25. The pneumatic vehicle tire as claimed in claim 11, wherein the two lateral sections, on an axial side of the pneumatic vehicle tire, cover at least an axially outermost belt edge of the belt.

26. The pneumatic vehicle tire as claimed in claim 11, wherein the at least one hybrid strength member of each of the two lateral sections have a fineness of not more than 500 dtex.

27. The pneumatic vehicle tire as claimed in claim 26, wherein the at least one hybrid strength member of each of the two lateral sections have a fineness of not more than 460 dtex.

28. The pneumatic vehicle tire as claimed in claim 11, wherein the at least one strength member of the central section has a fineness of not more than 600 dtex.

29. The pneumatic vehicle tire as claimed in claim 28, wherein the at least one strength member of the central section has a fineness of not more than 500 dtex.

30. The pneumatic vehicle tire as claimed in claim 1, wherein pneumatic vehicle tire is a tire for passenger cars.
